(19) United States
(12) Patent Application Publication
(10) Pub. No.: US 2016/0232557 A1
(43) Pub. Date: Aug. 11, 2016

(54) Systems and Methods for Managing Purchase Transactions Performed by Members of Groups

(71) Applicant: MASTERCARD INTERNATIONAL INCORPORATED, Purchase, NY (US)

(72) Inventors: Ciaran McMullan, Dublin (IE); Morta Sadlauskaite, Kilcock (IE); John Lennon, Bray (IE); Anthony Quaid, Maynooth (IE)

(21) Appl. No.: 14/619,648

(22) Filed: Feb. 11, 2015

(51) Int. Cl. G06Q 30/02

(52) U.S. Cl. CPC G06Q 30/0233

(57) ABSTRACT

Systems and methods are provided for managing purchase transactions by members of a group, where the group includes multiple members. In connection with the systems and methods, transaction data is accessed, via a processor, for a purchase transaction by a member of the group. The transaction data includes an amount of the purchase transaction. The processor then compares the amount of the purchase transaction to a metric amount. And, when the amount of the purchase transaction satisfies the metric amount (e.g., is about equal to or less than the metric amount, etc.), the processor transfers value to a reward account associated with the member.

### FIELD

The present disclosure generally relates to systems and methods for managing purchase transactions performed by members of groups, for example, in connection with rewarding the members for select ones of the purchase transactions that satisfy one or more predefined criteria.

### BACKGROUND

This section provides background information related to the present disclosure which is not necessarily prior art.

Members of organizations often incur expenses in connection with their responsibilities to the organizations (e.g., travel expenses, etc.). The expenses may be processed to payment accounts of the organizations, such that the organizations then settle the purchase transactions when due. Or, the expenses may be processed to payment accounts of the members. Here, the members settle the purchase transactions when due, and then request reimbursement from their organizations for the appropriate amounts. Separately, the payment accounts are typically provided to the members and/or the organizations by issuers that provide rewards for using the payment accounts. Often, the rewards are based on total amounts of the purchases processed to the payment accounts.

### DRAWINGS

The drawings described herein are for illustrative purposes only of selected embodiments and not all possible implementations, and are not intended to limit the scope of the present disclosure.

FIG. 1 shows an exemplary system for managing purchase transactions performed by members of a group;

FIG. 2 is a block diagram of an exemplary computing device, suitable for use in the exemplary system of FIG. 1; and

FIG. 3 is a block diagram of an exemplary method for managing a purchase transaction performed by a members of a group, which may be implemented in the exemplary system of FIG. 1.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Members of groups (e.g., employees of companies, etc.) often perform purchase transactions for products and/or services in connection with their responsibilities to the groups. For example, the members may incur expenses in connection with traveling on behalf of the groups, performing other duties for the groups, etc. Typically, the purchase transactions are funded by the groups, such that the members are not responsible for the corresponding amounts of the purchase transactions. Systems and methods herein reward members of groups when amounts of their purchase transactions satisfy various predefined criteria (e.g., are less than predefined metric amounts such as estimated appropriate and/or acceptable amounts for the purchase transactions, etc.). Through such gamification, the systems and methods may encourage members of the groups to take into account the overall amounts of their purchase transactions (e.g., choose cheaper options, etc.), prior to completing them, even though the members are not responsible for the amounts. In so doing, the systems and methods may aid groups in managing and/or controlling amounts of purchase transactions and, ultimately, reduce certain amounts (e.g., unneeded or unnecessary amounts, etc.) associated therewith.

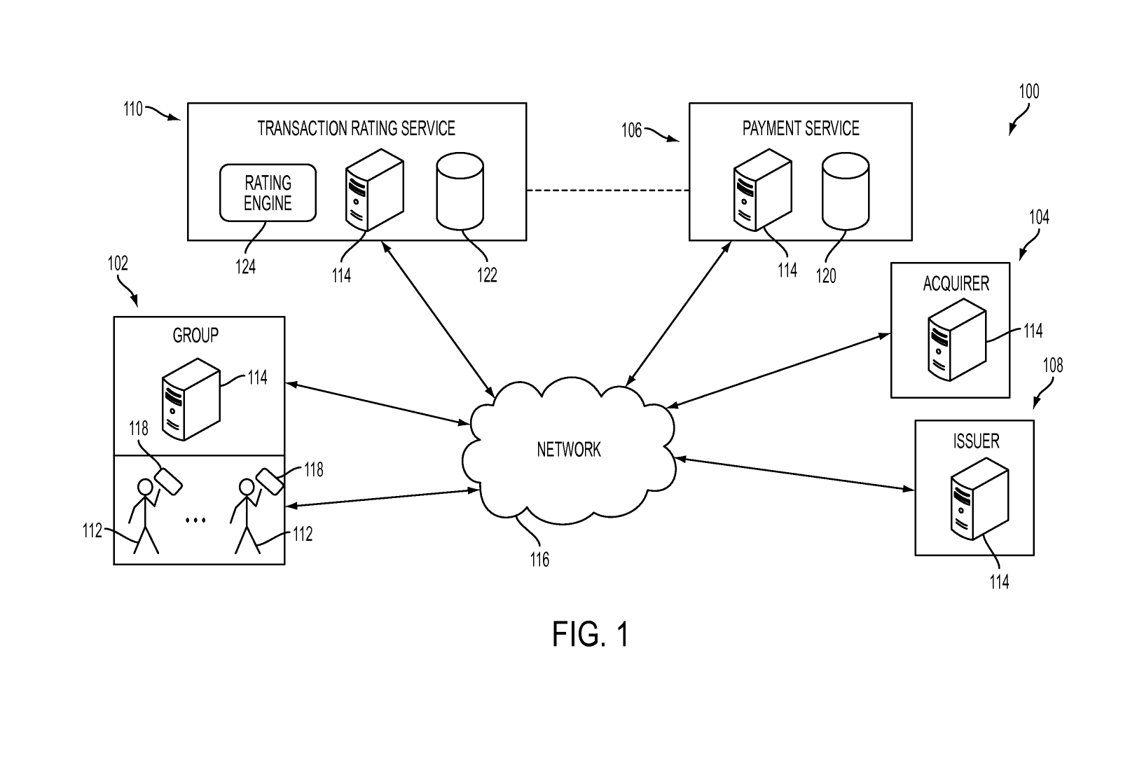

FIG. 1 illustrates an exemplary system 100, in which the one or more aspects of the present disclosure may be implemented. The system 100 can be used to manage purchase transactions performed by members of a group. In so doing, and as previously described, the system may help the group manage the amounts of the purchase transactions and, ultimately, reduce unnecessary or unneeded amounts associated therewith. Although components of the system 100 are presented in one arrangement, other embodiments may include the same or different components arranged otherwise, depending, for example, on arrangements and/or organizations of groups, payment of and/or reimbursement for purchase transactions by members of groups, processing of purchase transactions, etc.

The illustrated system 100 generally includes a group 102, an acquirer 104, a payment service 106, an issuer 108, and a transaction rating service 110. The group 102 may include a variety of different organizations such as, for example, companies, partnerships, etc. In addition, the group 102 generally includes multiple members (each indicated at 112), such as employees or others (e.g., other individuals, other entities, etc.) affiliated with the group 102, etc. While a single group 102 is illustrated in FIG. 1, it should be appreciated that the system 100 can accommodate multiple groups within the scope of the present disclosure. In addition, the transaction rating service 110 is illustrated as a separate entity in the system 100. However, the transaction rating service 110 may be implemented in one or more other entities shown, or not shown, in FIG. 1. For example, in some embodiments, the transaction rating service 110 may be implemented in the payment service 106 (as indicated by the broken lines in FIG. 1).

As shown in FIG. 1, the group 102, the acquirer 104, the payment service 106, the issuer 108, and the transaction rating service 110 each include a computing device 114, coupled to network 116. Each of the members 112 of the group 102 is also associated with a computing device 118, which is connected to network 116. The computing devices 114 and 118 may include a single computing device, or multiple computing devices located together and/or distributed across a geographic region. Each computing device 114 and 118 may include, without limitation, a server, a desktop computer, a laptop computer, a workstation computer, a personal computer, a tablet computer (e.g., an iPad™, a Samsung Galaxy™, etc.), a handheld computer or other communication device, a smart phone (e.g., an iPhone™, a BlackBerry™, etc.), the like, or combinations thereof.

The network 116 of the illustrated system 100 may include, without limitation, one or more local area networks (LAN), wide area networks (WAN) (e.g., the Internet, etc.), mobile networks, virtual networks, other networks as described herein, and/or other suitable public and/or private networks capable of supporting communication among two or more of the illustrated components, or even combinations thereof. In one example, the network 116 includes multiple networks, where different ones of the multiple networks are accessible to different ones of the illustrated components in FIG. 1.

In the system 100, a member 112 of the group 102 initiates a purchase transaction at a merchant for a desired product and/or service, in connection with performing responsibilities related to the group 102, by presenting a payment device to the merchant (and, in some cases, entering a personal identification number (PIN) associated with the payment device). The payment device is associated with a payment account issued by the issuer 108. In some implementations of the system 100, the payment device and related payment account are associated with the group 102 (as part of a group account). While in other implementations, the payment device and related payment account are associated directly with the member 112 (such that the member 112 may then request reimbursement for the purchase transaction from the group 102). The payment device may include any suitable device including, for example, a payment card (e.g., a credit card, a debit card, etc.), a payment token, a payment tag, a pass, another enabled device used to provide an account number (e.g., a mobile phone, a tablet, etc.), etc. And, the product and/or service may include any desired one or more product and/or service including, for example, a product and/or service relating to travel, etc.

In response, the merchant, the acquirer 104, the payment service 106, and the issuer 108 cooperate to authorize and clear the purchase transaction. In particular, the merchant (via the acquirer 104) communicates with the issuer 108, through the payment service 106 (e.g., using the MasterCard® interchange, etc.), for authorization for the transaction. If the issuer 108 accepts the transaction, an authorization response is provided back through the payment service 106 (and the associated payment network) to the merchant. And, the purchase transaction is completed. The credit of the payment account used by the member 112 is altered by the amount of the transaction, and the charge/credit is posted to the payment account. The transaction is later cleared by and between the acquirer 104 and the issuer 108, directly or via the payment service 106.

Transaction data is generated as part of the above interactions among the member 112, the merchant, the acquirer 104, the payment service 106, and the issuer 108. The transaction data includes various details of the purchase transaction such as, without limitation, a payment account number (PAN) for the payment account used by the member 112, an amount of the purchase transaction, a time/date of the purchase transaction, a merchant identification number (MID) for the merchant, a merchant category code (MCC) for the merchant, a name or other identifier of the member 112 making the purchase transaction, a reward account number for the member 112, etc. The transaction data may be stored at different entities participating in the interactions, along the payment network. In this embodiment, the transaction data is stored in a data structure 120 of the payment service 106, which may be incorporated in or separate from the computing device 114 of the payment service 106. In this and other embodiments, the transaction data may be stored as separate data related to the group 102 or member 112, as appropriate, and/or may be stored in combination with a variety of other transaction data or other data.

With continued reference to FIG. 1, upon completion of the purchase transaction by the member 112, the transaction rating service 110 evaluates/analyzes the transaction data in connection with a reward program supported by or provided by the transaction rating service 110. In particular, the transaction rating service 110 determines, from the transaction data, if any reward value (e.g., reward points, etc.) should be provided to the member 112, via a reward account associated with the member 112 through the reward program, for the purchase transaction.

As part of this evaluation/analysis, the transaction rating service 110 initially receives the transaction data. In some embodiments, the transaction data is received from the payment service 106, via the network 116. For example, the PAN of the payment account used by the member 112 in the purchase transaction may be associated with the member's reward account. And, when the payment service 106 receives the PAN, in connection with processing the purchase transaction, it also identifies that the PAN is associated with the reward account (as part of the reward program) and transmits the transaction data for the purchase transaction to the transaction rating service 110. Or the transaction rating service 110 may specifically request the transaction data for the member's purchase transaction from the payment service 106 (e.g., upon notification of the purchase transaction from the group 102, from the member 112, etc.). In other embodiments, the group 102 may provide the transaction data, for example, through one or more accounting programs (e.g., Smart Data Online™, etc.).

After receiving the transaction data, the transaction rating service 110 stores the transaction data in a data structure 122 of the transaction rating service 110. In so doing, the transaction data is identified to the member 112. The data structure 122 also includes transaction data for purchase transactions by multiple other members 112 of the group 102, and multiple other members of multiple other groups, etc. The data structure 122 may be incorporated in or separate from the computing device 114 of the transaction rating service 110.

In the illustrated system 100, the transaction rating service 110 includes a reward engine 124 configured, often by computer-readable instructions associated with the computing device 114 of the transaction rating service 110, to then access (or retrieve) the received transaction data in the data structure 122. In so doing, the reward engine 124 identifies an amount of the purchase transaction by the member 112 and assigns a category to the purchase transaction based on a type of the product and/or service involved in the purchase transaction (e.g., a hotel room category, a rental car category, an airline ticket category, etc.). The assigned category may or may not be additionally stored in the data structure 122 with the transaction data. The reward engine 124 also identifies, from the transaction data, the member 112 associated with the purchase transaction and an account number for the member's reward account. With that said, it should be appreciated that the reward engine 124 may be incorporated into the computing device 114 of the transaction rating service 110, or may be a separate computing device located together with and/or distributed apart from the computing device 114. In addition, while the reward engine 124 is described as performing various operations herein, it should be appreciated that a processor of the computing device 114 associated with the transaction rating service 110 may also or alternatively be used to perform one or more of the operations.

In some embodiments, the reward engine 124 of the transaction rating service 110 also transmits a retrieval notice to the computing device associated with the member 112, when the transaction data for the member's purchase transaction is retrieved from the data structure 122. In so doing, the member 112 is made aware that the purchase transaction is being processed and that rewards may be transferred to his/her reward account.

A corresponding metric amount (broadly, a predefined criteria) is also identified, based on the category of the purchase transaction, as a basis of comparison to the amount of the purchase transaction by the member 112. In the illustrated system 100, the metric amount is identified by the reward engine 124 of the transaction rating service 110, in the data structure 122, from multiple different metric amounts stored in the data structure 122. The multiple different metric amounts represent estimated appropriate and/or acceptable amounts (e.g., average or mean amounts, median amounts, mode amounts, etc.) for purchase transactions involving various products and/or services, and various categories of such products and/or services. The metric amounts may be based on amounts incurred in similar purchase transactions by others (e.g., by other members 112 of the group 102, by other consumers, etc.), or they may be based on appropriate and/or acceptable amounts for the products and/or services as offered by one or more select merchants (e.g., as determined, calculated, etc. by the merchants, by others, etc.), etc. In the illustrated system 100, the metric amounts are determined by the reward engine 124, based on transaction data received by the transaction rating service 110 for other similar purchase transactions (e.g., purchase transactions by other members 112 of the group 102 and assigned to the same categories, etc.). Further, in other embodiments, the metric amounts may be determined by other entities and then transmitted to the transaction rating service 110 upon request or as desired.

After the appropriate metric amount is identified, the reward engine 124 of the transaction rating service 110 is then configured to compare the amount of the member's purchase transaction to the metric amount. If the amount of the purchase transaction satisfies the metric amount (e.g., is about the same as or less than the metric amount; is less than the metric amount; is within a predetermined amount above the metric amount, equal to the metric amount, or less than the metric amount; etc.), the reward engine 124 then determines an appropriate reward value and transfers it to the member's reward account, based on the reward account number identified from the transaction data. Otherwise, no reward value is transferred.

The transaction rating service 110 (e.g., via the reward engine 124, etc.) also operates to cause one or more reward interfaces to display at the member's computing device 118 (via an output device), that permit the member 112 to view gamification information associated with the member's reward account, to redeem reward value, etc. Gamification information, as referred to herein, may include any information associated with providing one or more gaming related elements to the purchase transactions of the member 112. For example, in the illustrated system 100, gamification may include indicating the reward value of the member's purchase transaction when the amount of the member's purchase transaction satisfies the predefined metric amount criteria (or other predefined criteria, as may be desired), indicating a total reward value for the member's reward account, and providing (or adding) the newly earned reward value to the member's reward account. In connection therewith, the member 112 is able to view total reward value in the member's account, and potential reward levels for redemption, etc.

In addition, the transaction rating service 110 (e.g., via the reward engine 124, etc.) also permits the member 112 to view, through the one or more interfaces, additional information such as transaction data relating to the member's purchase transaction, transaction data relating to prior ones of the member's purchase transactions, one or more metric amounts applied to the member's purchase transactions, reward value redemption data, etc. Further, the transaction rating service 110 (e.g., again via the reward engine 124, etc.) also accepts inputs (e.g., transaction requests, etc.) from the member 112, again via the member's computing device 118 (via an input device) to redeem (or use) reward value from the member's reward account (e.g., to purchase one or more products, to redeem as cash value, etc.). Once used, the reward value is then debited, by the reward engine 124, from the member's reward account.

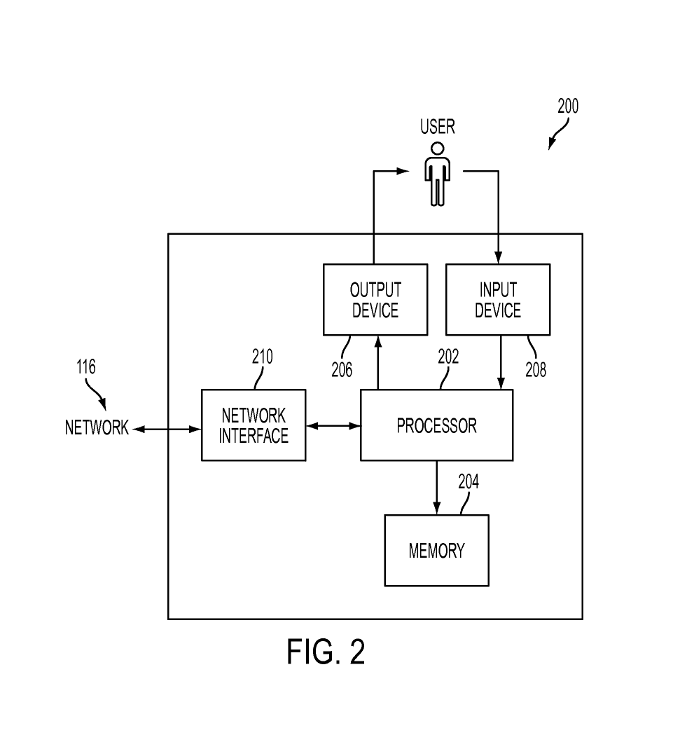

FIG. 2 illustrates an exemplary computing device 200. For purposes of the description herein, each of the computing devices 114 and 118 shown in FIG. 1 is a computing device, consistent with computing device 200. It should be appreciated that the computing devices 114 and 118 of FIG. 1 should not be understood to be limited to the arrangement of the computing device 200, as depicted in FIG. 2. Different components and/or arrangements of components may be used in other computing devices. In various embodiments, the computing device 200 includes multiple computing devices located in close proximity, or distributed over a geographic region.

The illustrated computing device 200 includes a processor 202 and a memory 204 that is coupled to the processor 202. The processor 202 may include one or more processing units (e.g., in a multi-core configuration, etc.). The computing device 200 is programmable to perform one or more operations described herein by programming the processor 202 and/or the memory 204. The processor 202 may include, but is not limited to, a general purpose central processing unit (CPU), a microcontroller, a reduced instruction set computer (RISC) processor, an application specific integrated circuit (ASIC), a programmable logic circuit (PLC), a gate array, and/or any other circuit or processor capable of the functions described herein. The above examples are exemplary only, and thus are not intended to limit in any way the definition and/or meaning of processor.

The memory 204, as described herein, is one or more devices that enable information, such as executable instructions and/or other data, to be stored and retrieved. The memory 204 may be configured to store, without limitation, transaction data relating to purchase transactions, categories for products and/or services involved in purchase transactions, metric amounts (or other predefined criteria) for products and/or services involved in purchase transactions, reward account data, and/or other types of data suitable for use as described herein, etc. In addition, the memory 204 may include one or more computer-readable media, such as, without limitation, dynamic random access memory (DRAM), static random access memory (SRAM), read only memory (ROM), erasable programmable read only memory (EPROM), solid state devices, flash drives, CD-ROMs, thumb drives, tapes, flash drives, hard disks, and/or any other type of volatile or nonvolatile physical or tangible computer-readable media. Further, computer-readable media may, in some embodiments, be selectively insertable to and/or removable from the computing device 200 to permit access to and/or execution by the processor 202 (although this is not required).

In various embodiments, computer-executable instructions may be stored in the memory 204 for execution by the processor 202 to cause the processor 202 to perform one or more of the functions described herein, such that the memory 204 is a physical, tangible, and non-transitory computer-readable media. It should be appreciated that the memory 204 may include a variety of different memories, each implemented in one or more of the functions or processes described herein.

The computing device 200 also includes an output device 206 and an input device 208 coupled to the processor 202.

The output device 206 outputs information and/or data (e.g., transaction data for purchase transactions, reward account data, or any other type of data, etc.) to a user by, for example, displaying, audibilizing, and/or otherwise outputting the information and/or data. In some embodiments, the output device 206 may comprise a display device such that various interfaces (e.g., webpages, etc.) may be displayed at computing device 200, and in particular at the display device, to display such information and/or data, etc. And in some examples, the computing device 200 may also (or alternatively) cause the interfaces to be displayed at a display device of another computing device, including, for example, a server hosting a website having multiple webpages, etc. With that said, the output device 206 may include, without limitation, a cathode ray tube (CRT), a liquid crystal display (LCD), a light-emitting diode (LED) display, an organic LED (OLED) display, an “electronic ink” display, speakers, combinations thereof, etc. In addition, the output device 206 may include multiple devices.

The input device 208 is configured to receive input from a user. For example, the input device 208 may be configured to receive any desired type of input from the user, for example, as part of evaluating transaction data, redeeming reward value, etc. In the exemplary embodiment, the input device 208 may include, without limitation, a keyboard, a pointing device, a mouse, a stylus, a touch sensitive panel (e.g., a touch pad or a touch screen, etc.), another computing device, and/or an audio input device. Further, in some exemplary embodiments, a touch screen, such as that included in a tablet, a smartphone, or similar device, may function as both the output device 206 and the input device 208.

With continued reference to FIG. 2, the computing device 200 also includes a network interface 210 coupled to the processor 202. The network interface 210 may include, without limitation, a wired network adapter, a wireless network adapter, a mobile telecommunications adapter, or other device capable of communicating to one or more different networks, including the network 116. In some exemplary embodiments, the computing device 200 includes the processor 202 and one or more network interfaces incorporated into or with the processor 202.

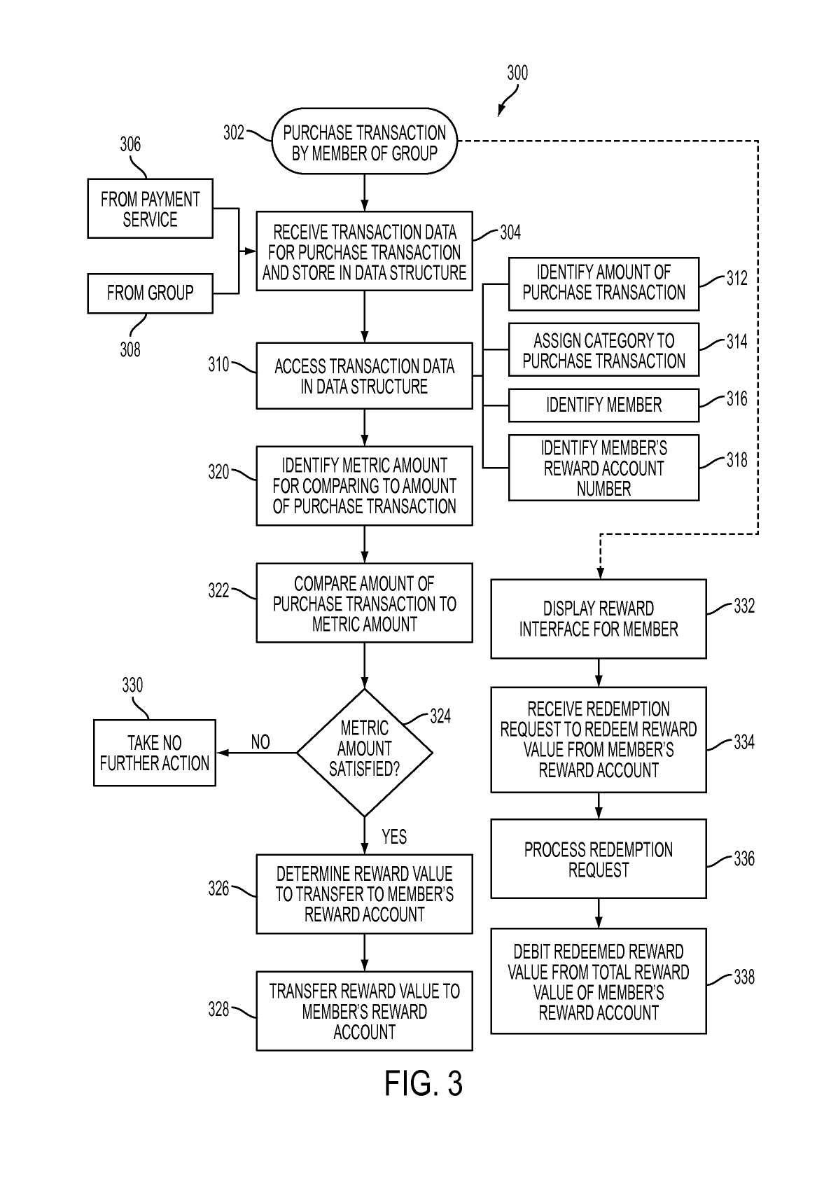

FIG. 3 illustrates an exemplary method 300 of managing the purchase transaction of the member 112, and particularly the amount of the purchase transaction, to help reduce any unnecessary or unneeded excess of such amount. The method 300 can be implemented in connection with the system 100 of FIG. 1 and is described herein as implemented in the transaction rating service 110 of the system 100 (e.g., in the computing device 114 of the transaction rating service 110, etc.), with further reference to the group 102, the acquirer 104, the payment service 106, the issuer 108, and the member 112. In addition, for purposes of illustration, the exemplary method 300 is described herein with reference to the computing device 200. However, the methods herein should not be understood to be limited to the exemplary system 100, or the exemplary computing device 200. Similarly, the systems and the computing devices herein should not be understood to be limited to the exemplary method 300.

As shown in FIG. 3, and as previously described in connection with the system 100, the member 112 of the group 102 initiates the purchase transaction at the merchant for a desired product and/or service at 302 by presenting the payment device to the merchant. In response, the merchant, the acquirer 104, the payment service 106, and the issuer 108 cooperate to authorize and clear the purchase transaction.

Upon completion of the purchase transaction at 302 (or before), the transaction rating service 110 receives the transaction data for the purchase transaction at 304 and stores the transaction data in the data structure 122. In some aspects, the transaction data is received from the payment service 106, at 306, based on the PAN of the payment account used by the member 112 in the purchase transaction. For example, when the payment service 106 receives the PAN, in connection with processing the purchase transaction, it also identifies that the PAN is associated with the reward program provided by the transaction rating service 110 and transmits the transaction data for the purchase transaction to the transaction rating service 110. In other aspects, the transaction data is received from the group 102, at 308. For example, when the member 112 submits a request to the group 102 for reimbursement of the amount associated with the purchase transaction, the group 102 then transmits the transaction data associated with the purchase transaction to the transaction rating service 110 (e.g., as part of the reimbursement request, etc.).

Next, at 310, the transaction rating service 110 accesses the transaction data for the purchase transaction, in the data structure 122 (e.g., via the reward engine 124, via the processor 202 associated with the computing device 114 of the transaction rating service 110, etc.). As part of accessing the transaction data at 310, the transaction rating service 110 identifies an amount of the purchase transaction by the member 112, at 312, and assigns a category to the purchase transaction, at 314, based on a type of the product and/or service involved in the purchase transaction (e.g., a hotel room category, a rental car category, an airline ticket category, etc.). Also as part of accessing the transaction data at 310, the transaction rating service 110 identifies the member 112 associated with the purchase transaction, at 316, and identifies an account number for the member's reward account, at 318.

At about the same time, or before or after, the transaction rating service 110 identifies a metric amount at 320 for use in comparing to the amount of the purchase transaction. In the illustrated method 300, the metric amount is identified in the data structure 122, from multiple different metric amounts, based on the category assigned to the purchase transaction at 314. And, the metric amount includes an average (or mean) amount for the purchase transaction, based on transaction data for related purchase transactions assigned to the same category as the member's purchase transaction and associated with multiple members 112 of the group 102. In some embodiments, the transaction rating service 110 may generate (or calculate) the metric amount (e.g., via the reward engine 124, etc.). While in other embodiments, the metric amount may be generated by other entities, and then transmitted to the transaction rating service 110.

The transaction rating service 110 then compares the amount of the member's purchase transaction to the metric amount at 322. If the amount of the purchase transaction satisfies the metric amount, at 324, the transaction rating service 110 determines a reward value at 326 to transfer to the member's reward account, and then transfers the determined reward value to the member's reward account at 328. In the illustrated method 300, the amount of the purchase transaction satisfies the metric amount, at 324, if it is about the same as or less than the metric amount. And, the reward value transferred to the member's reward account, at 328, includes a first point total for simply satisfying the metric amount and a second, additional point total for each dollar that the amount of the purchase transaction is less than the metric amount (i.e., for the difference between the amount of the purchase transaction and the metric amount). The first and second point totals are then combined as the reward value. It should be appreciated, however, that other reward value determinations may be used within the scope of the present disclosure. Alternatively, if the amount of the purchase transaction does not satisfy the metric amount at 324, the transaction rating service 110 takes no further action as indicated at 330 (e.g., with regard to the member's reward account, etc.).

In addition, at any time at a request of the member 112 or in connection with transferring reward value to the member's reward account (or both), the transaction rating service 110 causes a reward interface to display at the member's computing device 118 at 332 (via the output device 206), providing the member 112 with access to his/her reward account (e.g., via login credentials, etc.). Through the interface, the member 112 is then able to view various information relating to his/her reward account such as, for example, total reward value, different reward levels, reward value redemption options, purchase data for purchase transactions, metric amounts, etc. Also through the interface, the member 112 can redeem value from the reward account by submitting a redemption request to the transaction rating service 110. The redemption request is received by the transaction rating service 110 at 334, at the computing device 114 of the transaction rating service 110, and then processed as appropriate, by the computing device 114 of the transaction rating service 110, at 336 (e.g., by facilitating a purchase request for products and/or services using the redemption reward value, etc.). The redemption reward value is then debited, at 338, from the total reward value of the member's reward account (e.g., by the reward engine 124 in the data structure 122, etc.).

Again, and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following steps: (a) accessing transaction data for a purchase transaction by a member of a group having multiple members, where the transaction data includes an amount of the purchase transaction; (b) assigning a category to the purchase transaction based on a type of product and/or service associated with the purchase transaction; (c) generating a metric amount, based on transaction data for related purchase transactions assigned to the same category as the member's purchase transaction and associated with the multiple members of the group; (d) identifying the metric amount, in a data structure, from multiple different metric amounts based on the category of the purchase transaction; (e) comparing the amount of the purchase transaction to the metric amount; (f) transferring value to a reward account associated with the member, when the amount of the purchase transaction is about equal to or less than the metric amount; (g) receiving a transaction request from the member to use a redemption value from the member's reward account; and (h) debiting the redemption value from the total value of the member's reward account.

With that said, exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

As used herein, the term “and/or” includes any and all combinations of one or more of the associated listed items.

Although the terms first, second, third, etc. may be used herein to describe various elements and operations, these elements and operations should not be limited by these terms. These terms may be only used to distinguish one element or operation from another element or operation. Terms such as “first,” “second,” and other numerical terms when used herein do not imply a sequence or order unless clearly indicated by the context. Thus, a first element operation could be termed a second element or operation without departing from the teachings of the exemplary embodiments.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for managing purchase transactions by members of a group, where the group includes multiple members, the method comprising:
accessing, via a processor, transaction data for a purchase transaction by a member of a group having multiple members, the transaction data including an amount of the purchase transaction;
comparing, by the processor, the amount of the purchase transaction to a metric amount; and
transferring, by the processor, value to a reward account associated with the member, when the amount of the purchase transaction is about equal to or less than the metric amount.

2. The method of claim 1, further comprising:
assigning, by the processor, a category to the purchase transaction based on a type of product and/or service associated with the purchase transaction; and
identifying the metric amount in a data structure associated with the processor, from multiple different metric amounts, based on the category of the purchase transaction.

3. The method of claim 2, wherein the metric amount includes an average amount for the purchase transaction, based on transaction data for related purchase transactions assigned to the same category as the member's purchase transaction and associated with multiple members of the group.

4. The method of claim 3, wherein the transaction data for the purchase transactions used as the basis for the metric amount are associated with a payment account of the group; and
further comprising generating, by the processor, the metric amount, based on the transaction data for the related purchase transactions assigned to the same category as the member's purchase transaction and associated with the multiple members of the group.

5. The method of claim 1, wherein the transaction data for the purchase transaction by the member of the group is associated with a payment account of the group; and
wherein accessing transaction data for a purchase transaction by a member of a group includes receiving the transaction data, from the group payment account, via a payment service.

6. The method of claim 1, wherein the value transferred to the reward account associated with the member corresponds, at least in part, to a difference between the amount of the purchase transaction and the metric amount.

7. The method of claim 6, wherein the value transferred to the reward account associated with the member includes one or more points transferred to the member's reward account that can be redeemed by the member for products and/or services.

8. The method of claim 1, further comprising causing, by the processor, an interface to display at a computing device associated with the member, the interface including a value total for the member's reward account.

9. The method of claim 8, wherein the interface further includes the transaction data for the member's purchase transaction.

10. The method of claim 8, further comprising:
receiving, at the processor, a transaction request from the member, via the computing device associated with the member, to use a redemption value from the member's reward account; and
debiting, via the processor, the redemption value from the total value of the member's reward account.

11. A system for managing transactions by members of a group, where the group includes multiple such members, the system comprising:
a memory including a data structure, the data structure comprising transaction data for purchase transactions by multiple members of a group, the transaction data identified to particular ones of the members;
a processor coupled to the memory and configured to:
retrieve, from the data structure, transaction data for a purchase transaction by a member of the group, the transaction data including the amount of the purchase transaction;
transfer value to a reward account associated with the member, when the amount of the purchase transaction is about equal to or less than a metric amount of the purchase transaction; and
cause a reward interface to display at a computing device associated with the member, the reward interface including the value for the member's purchase transaction transferred to the member's reward account.

12. The system of claim 11, further comprising a payment service, the memory and the processor associated with the payment service.

13. The system of claim 11, wherein the data structure of the memory further includes multiple different metric amounts for multiple different categories of purchase transactions; and
wherein the processor is further configured to:
assign a category to the member's purchase transaction based on a type of product and/or service associated with the purchase transaction; and
identify the metric amount, from the multiple different metric amounts in the data structure of the memory, based on the category of the member's purchase transaction.

14. The system of claim 13, wherein the identified metric amount includes an average amount for the members' purchase transaction, based on transaction data for related purchase transactions assigned to the same category as the member's purchase transaction and associated with multiple members of the group.

15. The system of claim 11, wherein the processor is further configured to transmit a retrieval notice to the computing device associated with the member when the transaction data for the member's purchase transaction is retrieved from the data structure.

16. The system of claim 15, wherein the processor is further configured to determine the value for the member's purchase transaction, to be transferred to the member's reward account when the amount of the purchase transaction is about equal to or less than a metric amount of the purchase transaction, based at least in part on a difference between the amount of the purchase transaction and the metric amount.

17. The system of claim 16, wherein the processor is further configured to:
receive a transaction request from the member, via the computing device associated with the member, to use a redemption value from the member's reward account; and
debit the redemption value from a total value of the member's reward account.

18. A non-transitory computer readable media comprising computer-executable instructions which, when executed by at least one processor, cause the at least one processor to:
retrieve, from a data structure, transaction data for a purchase transaction by a member of a group comprising multiple members, the transaction data including the amount of the purchase transaction;
compare the amount of the member's purchase transaction to a metric amount;
transfer value to a reward account associated with the member, when the amount of the purchase transaction is about equal to or less than a metric amount of the purchase transaction; and
display, to the member at a computing device associated with the member, the value for the member's purchase transaction transferred to the member's reward account.

19. The non-transitory computer readable media of claim 18, wherein the computer-executable instructions, when executed by at least one processor, further cause the at least one processor to:
assign a category to the member's purchase transaction based on a type of product and/or service associated with the purchase transaction; and
identify the metric amount, from multiple different metric amounts in the data structure, based on the category of the member's purchase transaction.

20. The non-transitory computer readable media of claim 19, wherein the computer-executable instructions, when executed by at least one processor, further cause the at least one processor to:
receive a transaction request from the member, via the computing device associated with the member, to use a redemption value from the member's reward account; and
debit the redemption value from a total value of the member's reward account.
